(19) United States
(12) Patent Application Publication
(10) Pub. No.: US 2015/0082244 A1
(43) Pub. Date: Mar. 19, 2015

(54) CHARACTER INPUT DEVICE USING EVENT-RELATED POTENTIAL AND CONTROL METHOD THEREOF

(71) Applicant: THE INDUSTRY & ACADEMIC COOPERATION IN CHUNGNAM NATIONAL UNIVERSITY (IAC), Daejeon (KR)

(72) Inventors: Jin-Hun Sohn, Daejeon (KR); Jin-Sup Eom, Chungcheongbuk-do (KR)

(21) Appl. No.: 14/357,454

(22) PCT Filed: Oct. 4, 2013
(86) PCT No.: PCT/KR2013/008865

§ 371 Date: May 9, 2014

(30) Foreign Application Priority Data
May 20, 2013 (KR) 10-2013-0056497

(51) Int. Cl. G06F 3/01; G06F 3/0484

(52) U.S. Cl. CPC G06F 3/015; G06F 3/04842
USPC 715/822

(57) ABSTRACT

The present invention relates to a character input device using an event-related potential (ERP) and a control method thereof, and more specifically, to a character input device using a sub-block paradigm (SBP), which is a novel stimulus presentation paradigm capable of solving adjacency-distraction errors and double-flash problems while using a 6×6 character matrix. The character input method using an event-related potential in relation to an embodiment of the present invention includes the steps of: determining a first character to be input by a user among thirty six characters included in a 6×6 matrix; randomly flashing once for each of a plurality of sub-matrixes configured as a 2×3 matrix including six different characters among the 6×6 matrix; counting the number of times of flashes by the user when a first sub-matrix including the first character flashes among the plurality of sub-matrixes; generating the event-related potential (ERP) by the counting operation of the user; and extracting the first character using the generated ERP.

### TECHNICAL FIELD

The present invention relates to a character input device using an event-related potential (ERP) and a control method thereof, and more specifically, to a character input device using a sub-block paradigm (SBP) which is a novel stimulus presentation paradigm capable of solving adjacency-distraction errors and double-flash problems while using a 6×6 character matrix.

### BACKGROUND ART

Farwell and Donchin (1988) have invented a method of inputting characters into a computer using an event-related potential (ERP) which is a form of a brainwave, and this method presents a character stimulus using a row-column paradigm (RCP).

The RCP presents six rows and six columns of a 6×6 characters matrix as shown in FIG. 1 to flash one at a time for a short period of time in a random sequence.

If it is assumed that flashing once for each of all the six rows and six columns is one trial, twenty times of trials are conducted in maximum to input one character.

A user counts in mind the number of times of flashing a character desired to input. At a stimulus to which the user pays attention, amplitude of P300, which is a component of the ERP, is calculated to be large.

At this point, the character to which the user pays attention in order to input the character can be identified by observing P300 when each character flashes.

Since the ERP has a low signal-to-noise ratio, brainwaves are averaged after presenting a stimulus several times so as to obtain a reliable ERP.

Prior studies show that the number of trials attempted to input one character and accuracy of the input have a static relation (Donchin, Spencer, & Wijesinghe, 2000; Lenhardt, Kaper, & Ritter, 2008).

If the number of trials attempted to input one character is small, amplitude of P300 is calculated to be less reliable, and it is highly probable that a character desired to input by the user is different from a character identified using the amplitude of P300.

At this point, as the number of trials increases, accuracy of the input also increases. However, it is disadvantageous in that a time needed to input a character is extended as the number of trials is increased.

A lot of studies have been conducted on the accuracy of the RCP. Sellers and Krusienski, McFarland, Vaughan, Wolpaw, et al. (2006) calculated accuracy while changing the size of a stimulus matrix (3×3, 6×6) and inter-stimulus intervals (175 ms and 360 ms).

In such an accuracy test, twenty trials have been conducted per character.

As a result of calculating accuracy in an on-line space, the accuracy is about 80% when the size of a matrix is 6×6 and the presented inter-stimulus interval is 175 ms. Nijboer et al. (2008) conducted an experiment on eight patients suffering from amyotrophic lateral sclerosis. As a result of conducting twenty trials using a 6×6 stimulus matrix, accuracies of 82% and 62% are shown off-line and on-line, respectively.

Guger et al. (2009) conducted an experiment on eighty one normal adults.

That is, after conducting fifteen trials for each character, an accuracy of 91% is shown as a result of calculating the accuracy off-line.

Townsend et al. (2009) calculated accuracy in an on-line space after conducting three to five trials on eighteen people.

They used an 8×9 stimulus matrix, and an accuracy of 77.34% is calculated. As a whole, when fifteen or more trials are conducted for one character in the row-column paradigm, it is evaluated that the accuracy is at a level of 80 to 90%.

Although there are several causes which induce en error in the RCP, the main factor is one (Fazel-Rezai, 2007; Fazel-Rezai et al., 2012; Townsend et al., 2010).

In many cases of input errors, characters around a target character, particularly, characters in the same row or the same column are input as a target character by mistake. The problem occurred by such a cause is referred to as an adjacency-distraction error. The adjacency-distraction error occurs since a P300 response is induced by attracting attention of a user when a row or a column adjacent to the target character flashes (Townsend et al., 2010).

A study conducted by Fazel-Rezai (2007) shows that 80% of errors correspond to the adjacency-distraction error, and a study conducted by Townsend et al. (2010) shows that 85% of errors correspond to such a type of errors.

There are other causes which increase the possibility of generating an error in the RCP.

In the RCP, flashing six rows and six columns one at a time for a short period of time in a random sequence is repeated ten or more times.

As a result, a case in which a row or a column containing a target stimulus consecutively flashes (or at short intervals) always exists.

In this case, it is very difficult to concentrate on a character which flashes in the second place, and although it is possible to concentrate on the character, since P300 induced by the first flash is overlapped with P300 induced by the second flash, amplitude of the P300 is rather reduced as a result (Townsend et al., 2010).

The problem occurred by such a cause is referred to as a double-flash problem.

Townsend et al. (2010) have invented a checkerboard paradigm (CBP) in order to eliminate these two problems.

Referring to FIG. 2, the CBP uses an 8×9 character matrix.

In relation to the 8×9 character matrix, two virtual 6×6 matrixes (hereinafter, referred to as matrix 1 and matrix 2, respectively) are configured using thirty six characters included in the same pattern.

Here, when the 6×6 matrixes are configured, thirty six characters are randomly arranged.

In addition, six rows of matrix 1 are presented to flash one by one, and six rows of matrix 2 are presented one by one. Again, six columns of matrix 1 and then six columns of matrix 2 are presented to flash.

From the viewpoint of a user, it looks as if six characters randomly selected from the 8×9 matrix are repeated to flash simultaneously.

Accordingly, in the CBP, since the rows and columns of the 8×9 character matrix do not flash simultaneously, the adjacency-distraction error will be reduced, and the double-flash problem cannot occur structurally.

According to Townsend et al. (2010), in similar conditions, it is shown that accuracy of the RCP is 77.4%, whereas accuracy of the CBP is 91.5%.

However, the CBP has one disadvantage.

That is, a character matrix larger than needed should be used.

A character matrix larger than needed increases the number of times of flashing a character needed for one trial and increases a time required to input a character as a result. There is a problem in that although an RCP using a 6×6 character matrix requires twelve times of flashes for one trial, the CBP needs twenty four times of flashes.

Accordingly, required is a measure which can solve the problems of the RCP and the CBP described above.

### DISCLOSURE OF INVENTION

### Technical Problem

Therefore, the present invention has been made in view of the above problems, and it is an object of the present invention to provide a character input device using a sub-block paradigm (SBP) which is a new stimulus presentation paradigm capable of solving the adjacency-distraction error and the double-flash problem while using a 6×6 character matrix.

However, technical problems to be accomplished in the present invention are not limited to the technical problems mentioned above, and unmentioned other technical problems will be clearly understood by those skilled in the art from the following descriptions.

### Technical Solution

A character input method using an event-related potential (ERP) in relation to an embodiment of the present invention for accomplishing the above objects may include the steps of: determining a first character to be input by a user among thirty six characters included in a 6×6 matrix; randomly flashing once for each of a plurality of sub-matrixes configured as a 2×3 matrix including six different characters among the 6×6 matrix; counting the number of times of flashes by the user when a first sub-matrix including the first character flashes among the plurality of sub-matrixes; generating the event-related potential (ERP) by the counting operation of the user; and extracting the first character using the generated ERP.

In addition, the step of randomly flashing once for each of a plurality of sub-matrixes is a first trial, and the first trial may include thirty six times of flashes in total.

In addition, when the first trial is completed and the first character among the thirty six characters included in the 6×6 matrix flashes six times, characters on left and right sides of the first character may respectively flash four times, characters above and below the first character may respectively flash three times, and characters nearest to a diagonal line of the first character may respectively flash twice together with first character.

In addition, when a first sub-matrix which is any one of the plurality of sub-matrixes flashes, other sub-matrixes which does not have a character overlapped with the first sub-matrix may flash two or more times before any character among the six characters included in the first sub-matrix flashes again.

In addition, the character input method may further include a first step of flashing six rows and six columns of the 6×6 matrix one at a time; a second step of performing a stepwise linear discriminant analysis on the ERP generated through the first step; and a third step of calculating a first discriminant function for discriminating a target stimulus and a non-target stimulus through the stepwise linear discriminant analysis, and the first character may be extracted using the first discriminant function.

In addition, the character input method may further include the steps of: calculating an ERP for each of the thirty six characters by averaging the ERPs generated through the first step; calculating a probability of each of the thirty six characters for being a target character using the ERPs of the thirty six characters and the first discriminant function; and deriving a second discriminant function using the calculated probability, and the first character may be extracted using the second discriminant function.

Meanwhile, in a recording medium which can be read by a digital processing device in relation to an embodiment of the present invention for accomplishing the above objects, in which a program of commands that can be executed by the digital processing device to perform a character input method using an event-related potential (ERP) is implemented in a tangible form, the character input method using the event-related potential (ERP) may include the steps of: determining a first character to be input by a user among thirty six characters included in a 6×6 matrix; randomly flashing once for each of a plurality of sub-matrixes configured as a 2×3 matrix including six different characters among the 6×6 matrix; counting the number of times of flashes by the user when a first sub-matrix including the first character flashes among the plurality of sub-matrixes; generating the event-related potential (ERP) by the counting operation of the user; and extracting the first character using the generated ERP.

Meanwhile, a character input device using an event-related potential (ERP) in relation to an embodiment of the present invention for accomplishing the above objects includes: an interface unit connected to a user to acquire specific information from the user; a display unit for displaying a 6×6 matrix including thirty six characters; and a control unit for controlling to randomly flash once for each of a plurality of sub-matrixes configured as a 2×3 matrix including six different characters among the 6×6 matrix, in which when the first character is determined among the thirty six characters by the user, and a first sub-matrix including the first character among the plurality of sub-matrixes flashes, and the user counts the number of times of the flashing, the ERP generated from a brain of the user by the counting operation of the user is acquired through the interface unit, and the control unit controls to extract the first character using the generated ERP and display the extracted first character through the display unit.

In addition, the step of randomly flashing once for each of a plurality of sub-matrixes is a first trial, and the first trial may include thirty six times of flashes in total.

In addition, when the first trial is completed and the first character among the thirty six characters included in the 6×6 matrix flashes six times, characters on left and right sides of the first character may respectively flash four times, characters above and below the first character may respectively flash three times, and characters nearest to a diagonal line of the first character may respectively flash twice together with first character.

In addition, when a first sub-matrix which is any one of the plurality of sub-matrixes flashes, the control unit may control to flash other sub-matrixes which does not have a character overlapped with the first sub-matrix two or more times before any character among the six characters included in the first sub-matrix flashes again.

In addition, the control unit may perform a first step of randomly flashing once for each of a plurality of sub-matrixes configured as a 2×3 matrix including six different characters among the 6×6 matrix, perform a stepwise linear discriminant analysis on the ERP generated through the first step, calculate a first discriminant function for discriminating a target stimulus and a non-target stimulus through the stepwise linear discriminant analysis, and extract the first character using the first discriminant function.

In addition, the control unit may circulate an ERP for each of the thirty six characters by averaging the ERPs generated through the first step, circulate a probability of each of the thirty six characters for being a target character using the ERPs of the thirty six characters and the first discriminant function, derive a second discriminant function using the calculated probability, and extract the first character using the second discriminant function.

### Advantageous Effects

A character input device using an event-related potential (ERP) and a control method thereof in relation to at least one embodiment of the present invention configured as described above can be provided to a user.

Specifically, a character input device using a sub-block paradigm (SBP), which is a novel stimulus presentation paradigm capable of solving adjacency-distraction errors and double-flash problems while using a 6×6 character matrix, can be provided to a user.

However, the effects that can be obtained from the present invention are not limited to the effects described above, and unmentioned other effects will be clearly understood by those skilled in the art from the following descriptions.

### BRIEF DESCRIPTION OF THE DRAWINGS

FIG. 1 is a view showing an example of an RCP which presents six rows and six columns from a 6×6 characters matrix so as to flash one at a time for a short time period in a random sequence in relation to the present invention.

FIG. 2 is a view showing a specific example of a CBP using an 8×9 characters matrix in relation to the present invention.

FIG. 3(A) is a view showing a specific example of an SBP which simultaneously flashes six characters adjacent to each other, and FIG. 3(B) is a view showing an example of a distribution chart in which a character farther from a target stimulus has smaller P300 amplitude.

FIG. 4 is a flowchart illustrating the specific operation of a character input device according to the present invention.

FIG. 5 is a view showing a specific example of accuracy, a bit rate per minute, the number of characters input per minute of the RCP and the SBP in relation to the present invention.

FIG. 6 is a view showing a specific example of an ERP calculated in the RCP and an ERP calculated in the SBP in relation to the present invention.

FIG. 7 is a view comparing ERPs of a target stimulus calculated from each of the paradigms in relation to the present invention.

FIG. 8 is a view analyzing types of errors in the RCP and the SBP, which shows how far the generated errors are from a target stimulus.

FIG. 9 is a block diagram showing the configuration of a character input device according to the present invention.

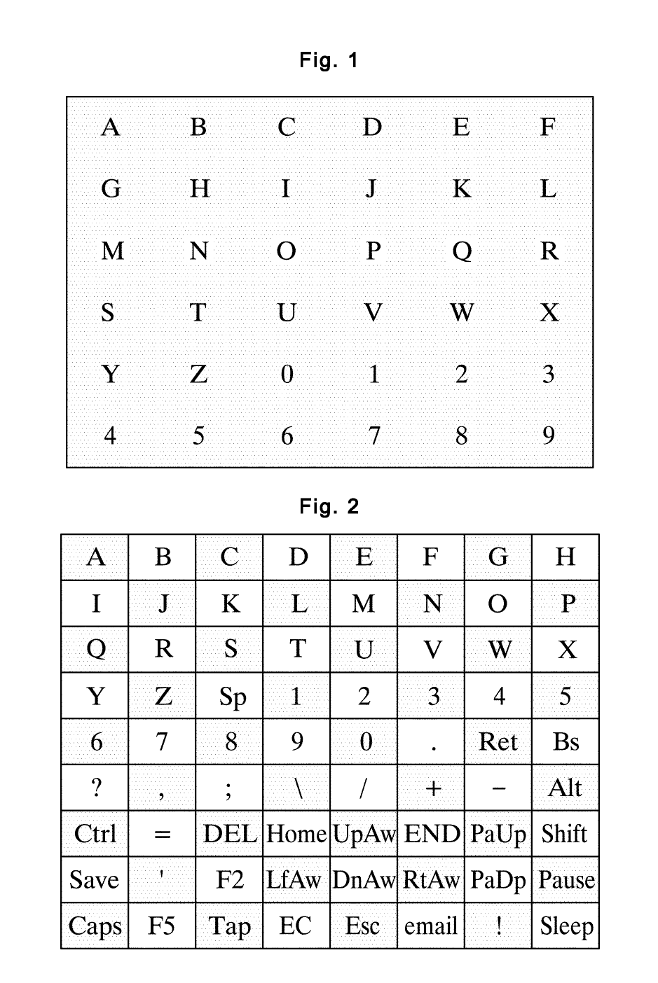

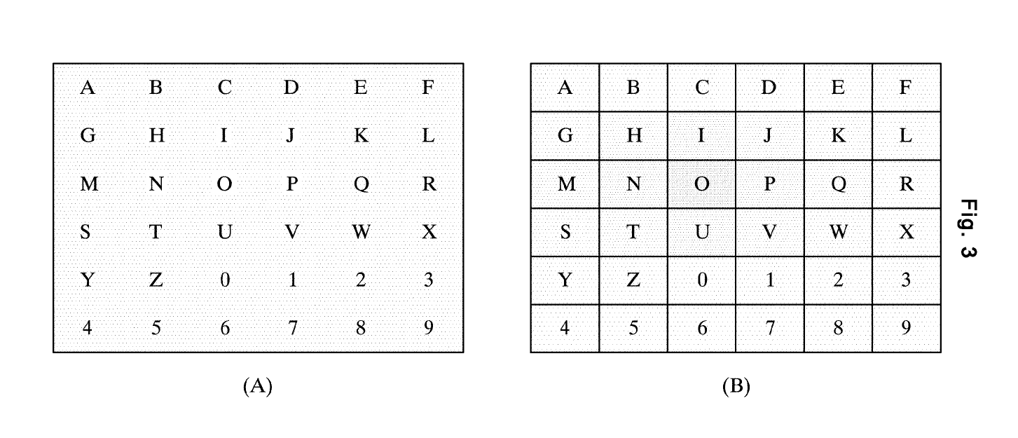

### BEST MODE FOR CARRYING OUT THE INVENTION

Hereinafter, a sub-block paradigm (SBP) which can be applied to the present invention will be described in detail before specifically describing a character input device using a stimulus presentation method according to the present invention.

An event-related potential is a brainwave record recording electrical responses of the cerebrum generated in response to a specific stimulus in a portion of the scalp. Since a measurement value is obtained by repetitively presenting a same stimulus and averaging potentials induced by the stimulus, it is also referred to as an average evoked potential. Time resolution thereof is extremely high so as to show changes of brain activities by the unit of 1/1,000 second.

As described above, the row-column paradigm (RCP) has adjacency-distraction errors of erroneously inputting characters arranged around a target character, particularly, characters in the same row or the same column as a target character and has double-flash problems in which it is very difficult to concentrate on a character flashing in the second place when a row or a column including a target character consecutively flashes, and, although it is possible to concentrate on the character, since P300 induced by the first flash is overlapped with P300 induced by the second flash, amplitude of the P300 is rather reduced as a result.

In addition, a checkerboard paradigm (CBP) has a problem in that a character matrix larger than needed should be used, and the character matrix larger than needed increases the number of times of flashing a character needed for one trial and increases a time required to input a character as a result.

Accordingly, an object of the present invention is to propose a sub-block paradigm (SBP) which is a novel stimulus presentation paradigm capable of solving the adjacency-distraction error and the double-flash problem while using a 6×6 character matrix.

FIG. 3(A) is a view showing a specific example of an SBP which simultaneously flashes six characters adjacent to each other, and FIG. 3(B) is a view showing an example of a distribution chart in which a character farther from a target stimulus has smaller P300 amplitude.

Referring to FIG. 3(A), six characters adjacent to each other (i.e., a 2×3 sub-block) flash simultaneously.

Thirty six times of flashes are needed to flash all the 2×3 sub-blocks included in the 6×6 character matrix, and at this point, each character flashes six times in total.

That is, thirty six times of flashes make one trial.

In the SBP, the number of times of flashing the characters adjacent to a target character together with the target character is changed systematically.

When a target stimulus flashes six times in one trial, two characters on the left and right sides of the target stimulus flash twice, two characters above and below the target stimulus flash three times, characters in the diagonal direction and characters next to the characters on the left and right sides of the target stimulus flash twice respectively, and characters in the vicinity of the diagonal line flash once together with the target stimulus.

As an effect of such a method, the amplitude of P300 is reduced as a character is farther from a target stimulus as shown in FIG. 3(B).

Since magnitude of the adjacency-distraction effect is determined depending on a distance from a target stimulus, in the SBP, also the adjacency-distraction effect will show a distribution similar to FIG. 3(B).

A distribution chart can be used when a character desired to input by a P300 character input device user is determined.

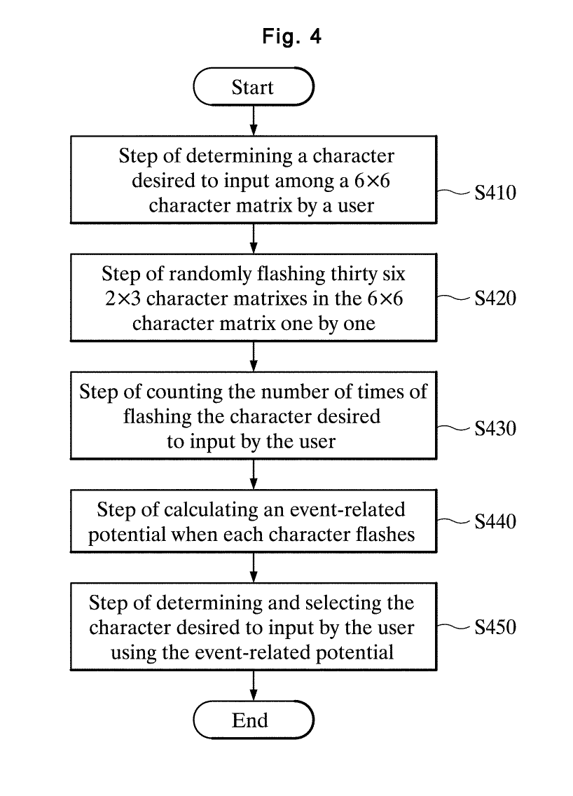

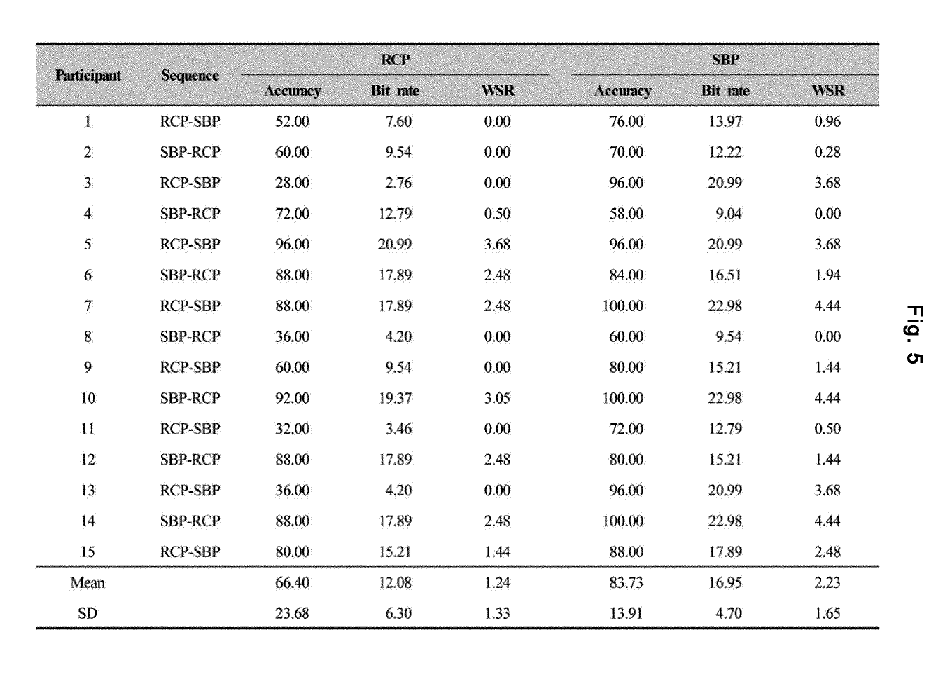

FIG. 4 is a flowchart illustrating the specific operation of a character input device according to the present invention.

Referring to FIG. 4, first, a step of thinking the number of times of flashing a character desired to input by a user among a 6×6 character matrix is progressed (S410).

Then, a step of randomly flashing, one by one, thirty six 2×3 character matrixes included in the 6×6 character matrix is progressed (S420).

After step S420, a step of counting the number of times of flashing the character desired to input by the user is progressed (S430).

In addition, a step of calculating an event-related potential when each character flashes is progressed (S440).

Then, a step of discriminating and selecting a character desired to input by the user using the event-related potential is progressed (S450).

The RCP determines a target character using only the brainwaves generated when each character is presented, whereas the SBP uses all the brainwaves related to a target character and neighboring characters, and thus accuracy of the SBP is further higher.

As described above, the double-flash problem always occurs in the RCP when six rows and six columns flash one by one.

However, the SBP may effectively control the double-flash problem when thirty six sub-blocks flash one by one.

A sequence may be determined to flash a character belonging to a sub-block after at least two flashes are made after the sub-block is flashed.

Hereinafter, referring to FIGS. 5 to 8, it is evaluated through an experiment whether or not the SBP, which is designed to use the adjacency-distraction effect for confirming a target character and not to generate the double-flash problem, shows accuracy higher than that of the RCP.

In relation to the people taking part in the experiment, fifteen persons participated in the experiment. Eight men participated in the experiment, and their age is 25.8 in average (ranging from 22 to 45).

Five persons among them have an experience of participating in an experiment of P300 character input device, and ten persons take part in the experiment of P300 character input device for the first time.

The participants of the experiment are adults who do not have a medical history of brain damage or a problem of eyesight.

In relation to equipment of the experiment, 6×6 character matrix stimuli are presented on a 19-inch LCD monitor 60 cm placed before the participants of the experiment. The width of each character is 1.1 cm, and the height is 1.3 cm. The horizontal space between characters is 5 cm, and the vertical space is 3 cm. Electrodes are attached to Fz, Cz, Pz, Oz, P3, P4, PO7 and PO8 to measure brainwaves (Krusienski, Sellers, McFarland, Vaughan, & Wolpaw, 2008), and a ground electrode is attached to the forehead, and a reference electrode is attached to both earlobes.

The brainwaves are amplified by 20,000 times after passing through a band of 0.3 to 30 Hz using a Grass Model 12 Neurodata Acquisition System (Grass Instruments, Quincy, Mass., USA) and stored in a computer at a sampling rate of 200 Hz using MP150 (BioPac Systems Inc., Santa Barbara, Calif., USA).

A program for presenting a stimulus and storing a brainwave is manufactured using Visual C++ v6.

In relation to the procedure of the experiment, the experiment has been conducted twice in total. One is performed in the RCP, and the other is performed in the SBP. Each experiment is configured of two phases. The first phase is a training phase for estimating a discriminant function used for confirming a target character.

The second phase is a testing phase, in which a character desired to input by a participant of the experiment is determined by using the discriminant function calculated in the training phase.

Through these phases, it is confirmed whether or not a character desired to input by a participant of the experiment corresponds to the character discriminated through the discriminant analysis.

In both the training phase and the testing phase, a character to be input by the participant of the experiment is presented in an upper portion of the screen. The work the participant of the experiment needs to do is counting in mind the number of times of flashing the character to be input. In the training phase, eighteen characters selected among the thirty six characters to be evenly distributed in the space are used as target characters.

Words and digit strings are used in the testing phase.

Since the experiment of the P300 character input device requires considerable attention, length of experiment varies depending on the experience of using the P300 character input device.

Five participants of the experiment having an experience in the RCP and the SBP have input fifty characters (ten words and one digit string) in total in the testing phase, and ten participants of the experiment without having an experience in the experiment have input twenty five characters (five words and one digit string) in total in the testing phase.

In the RCP, six rows and columns are presented one at a time in a random sequence with a high strength (from a gray character with a normal thickness to a white bold character) for 100 ms and with a medium strength for 25 ms. As a result, it looks as if either a row or a column continuously flashes every 125 mn.

Flashing once for each of the six rows and six columns while inputting one character is assumed as one trial, and total nine trials are repeated.

In the SBP, one of the thirty six 2×3 sub-blocks is presented with a high strength for 100 ms, and the other 2×3 sub-blocks are presented with a high strength every 125 ms. Flashing once for each of the thirty six sub-blocks is assumed as one trial, and total three trials are repeated.

The sequence of flashing the thirty six sub-blocks is predetermined, and it is a sequence constructed such that after a block flashes, at least two other blocks flash before a certain character belonging to the block flashes again.

Ten sequences are constructed, and one of the ten sequences is randomly selected and used.

One trial in the SBP consumes a time period corresponding to three trials in the RCP, and the number of times of flashing each character is also the same.

That is, in both of the paradigms, it takes 13.5 seconds to input one character, and each character flashes eighteen times. If it is assumed that inputting one character is one session, eighteen sessions are required in the training phase, and twenty five or fifty sessions are required depending on the participant of the experiment in the testing phase. The order of experiments of the RCP and the SBP is balanced for each participant of the experiment.

A practice trial for learning each paradigm is less than three minutes. After finishing the experiment, the participants of the experiment are asked to evaluate how convenient each paradigm is to use based on a seven-point Likert scale.

Here, one-point means ‘very difficult’, four-point means ‘moderate’, and seven-point means ‘very easy’.

In relation to the classification applied to the experiment, after calculating a discriminant function by performing a stepwise linear discriminant analysis (SWLDA) on the brainwaves recorded in the training phase, a target character is grasped in the testing phase using the discriminant function.

In the RCP, the stepwise linear discriminant analysis is performed through the steps described below. Flashing one row or one column in a session of inputting one character is progressed one hundred and eight times, and the brainwaves are recorded in eight portions of the scalp while the flashes are progressed.

One analysis unit is created by cutting off the brainwaves for 750 ms after one row or one column starts to be presented. One hundred and eight brainwave analysis units are created per eight electrodes in a session.

One analysis unit recorded at one electrode is configured of one hundred and fifty (0.750 sec×200 Hz) values. These analysis units are divided into a case of a row or a column including a target stimulus and a case which does not include a target stimulus.

As a result, a 108×1200 brainwave matrix is created in a session.

Since total eighteen characters are input in the training phase, a 1944×1200 matrix is created, and a discriminant function for discriminating a target stimulus and a non-target stimulus is calculated by performing a stepwise discriminant analysis on the matrix.

In the testing phase of the RCP, it is determined what the target stimulus is in each session.

First, an ERP is calculated for each of the thirty six characters by averaging eighteen brainwave analysis units when each character flashes for each of the thirty six characters. These ERPs configure a 36×1200 matrix.

A probability of each row (i.e., each character) for being a target character is calculated for thirty six rows by applying the discriminant function derived in the training phase.

A character of the highest probability for being a target character is finally selected among the thirty six characters. A target character is grasped by repeating this procedure in each session.

In the SBP, one step is added to the steps used in the RCP.

In the training phase, the discriminant function is derived first by using a method the same as that of the RCP (hereinafter, referred to as a primary discriminant function), and an ERP is calculated for the brainwaves of the training phase by using a method the same as that of the RCP. Next, a probability of each of the thirty six characters for being a target character is calculated by applying the discriminant function derived in the training phase to the ERP obtained in the training phase.

Naturally, as shown in FIG. 3(B), the probability of the target character is the highest, and a probability value is lowered toward the edges.

Now, the observed probability values are rearranged based on a probability value expected when each character is a target character. A 36×36 matrix is created using thirty six probability values.

One of the rows represents a probability distribution of an actual target stimulus, and the others represent a probability distribution of a non-target stimulus.

A 648×36 matrix is configured by performing the same work for the eighteen sessions.

A discriminant function for discriminating a target stimulus and a non-target stimulus (hereinafter, referred to as a secondary discriminant function) is derived by performing a stepwise linear discriminant analysis on the matrix.

In the testing phase of the SBP, a probability of each of the thirty six characters for being a target character is calculated using the primary discriminant function in a method the same as that of the RCP.

A 36×36 matrix is created by rearranging thirty six probabilities based on a probability distribution expected when each character is a target character in the same manner as that of the training phase.

Then, the probability of each character for being a target character is calculated by applying the secondary discriminant function to each row (i.e., each character), and a character of the highest probability is selected as a target character.

In relation a transmission rate, performance of the character input device can be evaluated by the number of characters that can be input per minute (Furdea et al., 2009).

The number of characters input per minute (written symbol rate: WSR) can be calculated through the number of bits B transmitted per trial and a character transmission rate (symbol rate: SR) (McFarland & Wolpaw, 2003). B is calculated using mathematical expression 1 shown below (Pierce, 1980).

$$B = {log}_{2} N + P {log}_{2} P + ( 1 - P ) {log}_{2} ( \frac{1 - P}{N - 1} ) \qquad [ Mathematical expression 1 ]$$

In the above mathematical expression, N denotes the number of total characters, and P denotes the probability of a target stimulus for being correctly classified. The SR is calculated using B according to mathematical expression 2 shown below.

$$SR = \frac{B}{{log}_{2} N} \qquad [ Mathematical expression 2 ]$$

Finally, the WSR is calculated using mathematical expression 3 shown below.

$$W S R = \{ \begin{matrix}\frac{2 SR - 1}{T} & SR > 0.5 \\ 0 & SR \leq 0.5\end{matrix} \qquad [ Mathematical expression 3 ]$$

Here, T denotes a value expressing a time required for one trial by the unit of minutes.

An SR smaller than 0.5 means that frequency of errors is higher than the frequency of correctly inputting a character.

In a real situation, an error should be corrected, and input (erase) of a character should be added once in order to correct the error.

Since a sentence free from an error cannot be created when the SR is smaller than 0.5, the WSR has a value of zero.

A result of the experiment mentioned above is described below.

First, the accuracy and the transmission rate will be described.

FIG. 5 presents accuracy, a bit rate per minute, the number of characters input per minute of the RCP and the SBP.

Referring to FIG. 5, accuracy of the SBP is 83.73%, which is higher than 66.40% of the accuracy of the RCP to be statistically significant (t(14)=2.87, p<0.05), and even the bit rate per minute, which is a function of accuracy, of the SBP is 16.95 to be higher than 12.08 of the RCP (t(14)=3.01, p<0.01), and the WSR of the SBP is 2.23 to be larger than 1.24 of the RCP (t(14)=2.71, p<0.05).

Observing accuracy of each participant of the experiment, eleven out of fifteen persons show higher accuracy in the SBP than in the RCP, and three persons show higher accuracy in the RCP than in the SBP (participants 4, 6 and 12), and one participant shows the same accuracy in the two paradigms.

Among the eleven participants showing higher accuracy in the SBP, some of the participants have conducted an experiment on the SBP, and some of the participants have conducted an experiment on the RCP.

However, since all the three persons showing higher accuracy in the RCP are participants who have conducted the experiment on the SBP first and on the RCP later, it is probable that these three persons might have obtained higher accuracy in the RCP owing to an effect of exercise.

In order to verify the experiment, an analysis of variance has been performed based on a Latin square design which uses an experiment set as an independent variable and the accuracy as a dependent variable (Park, 2003). As a result of the analysis, the effect of the order of experiment approaches a level of significance (F(1,26)=3.02, p=0.094). An average of the estimated accuracy of the experiment conducted first is 68.93%, and an average of the estimated accuracy of the experiment conducted second is 81.43%, and thus the accuracy of the experiment conducted in the second place tends to be higher.

Next, the event-related potential will be described.

ERPs calculated in the RCP and ERPs calculated in the SBP are presented in FIG. 6.

Since P300 of a target stimulus is most outstanding in the Pz zone (Polich, 2007), only the ERPs of the Pz zone are presented.

In both of the two paradigms, amplitude of the positive peak of the target stimulus is calculated as being larger than the amplitude of the positive peak of the non-target stimulus to be statistically significant (RCP, t(14)=5.58, p<0.001; SBP, t(14)=7.33, p<0.001). The positive peak appears about 230 ms after the stimulus is presented.

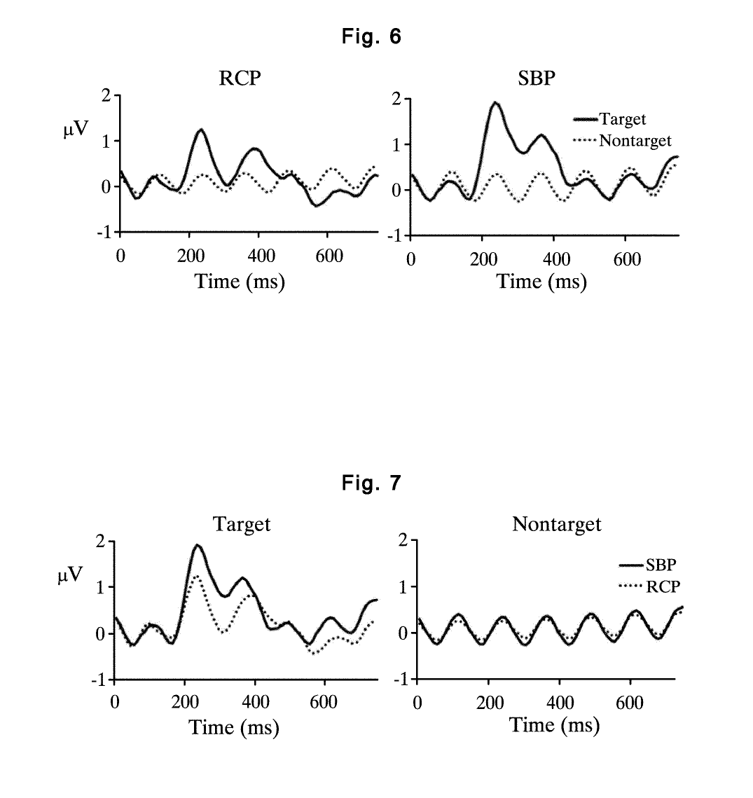

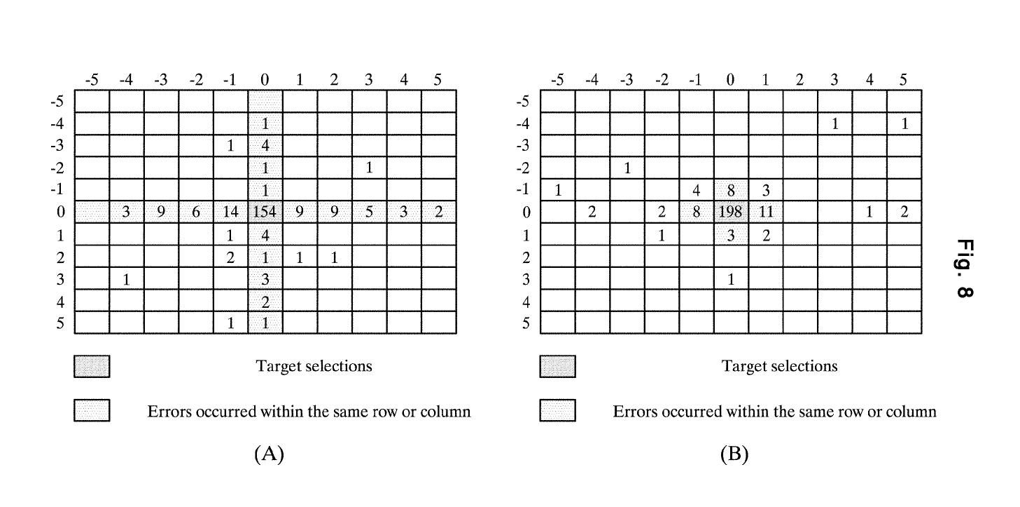

ERPs of the target stimulus calculated in the two paradigms are compared as shown in FIG. 7. It is shown that amplitudes of the positive peaks of the target stimulus are different from each other in the two paradigms, and it is also shown that the amplitude of the positive peak of the SBP is larger than the amplitude of the positive peak of the RCP to be statistically significant (t(14)=2.55, p<0.05).

In addition, details related to the error analysis will be described.

Types of errors in the RCP and the SBP are analyzed. FIG. 8 presents how far the generated errors are from a target stimulus.

Total ninety six errors occurred in the case of the RCP, and seventy eight (81.25%) errors among them occurred in a row or a column including the target stimulus.

Total fifty two errors occurred in the case of the SBP, and thirty (57.69%) errors among them occurred in a character flashing together with the target stimulus more than 50%.

The adjacency-distraction error of the RCP tends to be higher ((1)=9.49, p<0.01).

Meanwhile, convenience of using the character input device is as described below.

It is inquired how easy is it to use the RCP and the SBP. All the participants of the experiment answered that the SBP is easier to use than the RCP.

An average of the convenience of using the RCP is 2.60 (SD=1.06), showing a value corresponding to ‘difficult’, and an average of the convenience of using the SBP is 5.20 (SD=0.86), showing a value corresponding to ‘slightly easy’. There is a statistically significant difference between the two averages (t(14)=10.22, p<0.001).

Hereinafter, a character input device applying the SBP described above will be described in detail.

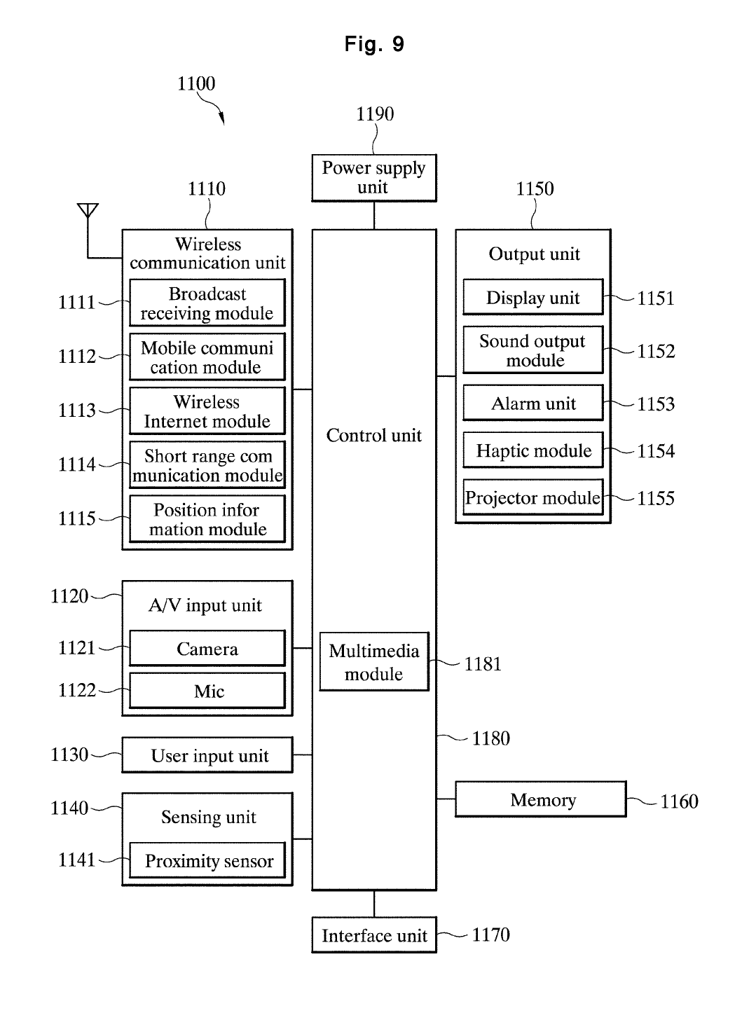

FIG. 9 is a block diagram showing the configuration of a character input device according to the present invention.

The character input device 1100 may include a wireless communication unit 1110, an Audio/Video (A/V) input unit 1120, a user input unit 1130, a sensing unit 1140, an output unit 1150, a memory 1160, an interface unit 1170, a control unit 1180, a battery 1190 and the like. Since the constitutional components shown in FIG. 9 are not indispensable, a character input device having constitutional components more than or less than the character input device 1100 can be implemented.

Hereinafter, the constitutional components will be described in order.

The wireless communication unit 1110 may include one or more modules which allow wireless communication between the character input device 1100 and a wireless communication system or between the character input device 1100 and a network in which the character input device 1100 is placed. For example, the wireless communication unit 1110 may include a mobile communication module 1112, a wireless Internet module 1113, a short range communication module 1114, a position information module 1115 and the like.

The mobile communication module 1112 transmits and receives wireless signals to and from at least one of a base station, an external terminal and a server on a mobile communication network. The wireless signals may include various types of data according to transmission and reception of a voice call signal, a video communication call signal or a character/multimedia message.

The wireless Internet module 1113 is a module for wireless Internet connection, which can be installed inside or outside of the character input device 1100.

Wireless LAN (WLAN)(Wi-Fi), Wireless broadband (Wibro), World Interoperability for Microwave Access (Wimax), High Speed Downlink Packet Access (HSDPA) or the like can be used as a technique of the wireless Internet.

The short range communication module 1114 is a module for performing short range communication. Bluetooth, Radio Frequency Identification (RFID), Infrared Data Association (IrDA), Ultra Wideband (UWB), ZigBee or the like can be used as a technique of the short range communication.

The position information module 1115 is a module for acquiring a position of the character input device 1100, and a representative example thereof is a Global Position System (GPS). According to the present technique, the GPS module 1115 may accurately calculate three-dimensional current position information according to latitude, longitude and altitude by calculating information on the distance from three or more satellites and accurate time information and then applying trigonometry to the calculated information. Currently, a method of calculating position and time information using three satellites and correcting errors of the calculated position and time information using another satellite is widely used. In addition, the GPS module 1115 may calculate speed information by continuously calculating the current position in real-time.

Referring to FIG. 9, the Audio/Video (A/V) input unit 1120 is for inputting audio signals or video signals, which may include a camera 1121, a mic 1122 and the like. The camera 1121 processes an image frame such as a still image, a moving image or the like obtained by an image sensor in a video communication mode or a photographing mode. The processed image frame can be displayed on a display unit 1151.

The image frame processed by the camera 1121 can be stored in the memory 1160 or transmitted to outside through the wireless communication unit 1110.

At this point, two or more cameras 1121 can be provided according to a use environment.

For example, the camera 1121 may be provided with first and second cameras 1121a and 1121b for taking 3D images on a side opposite to the display unit 1151 of the character input device 1100 and a third camera 1121c for self-photographing at some portions on a side provided with the display unit 1151.

At this point, the first camera 1121a may be for taking a left eye image, which is a source image of a 3D image, and the second camera 1121b may be for taking a right eye image.

The mic 1122 receives an external sound signal through a microphone in a communication mode, a recording mode, a voice recognition mode or the like and processes the sound signal into an electrical voice data. In the case of the communication mode, the processed voice data may be converted and output in a form that can be transmitted to a mobile communication base station through the mobile communication module 1112. In the mic 1122, a variety of noise reduction algorithms may be implemented to remove noises generated in the process of receiving external sound signals.

The user input unit 1130 generates input data for a user to control operation of the character input device.

The user input unit 1130 may receive a signal, from the user, specifying two or more contents among the contents displayed according to the present invention. In addition, the signal specifying two or more contents may be received through a touch input or input of a hard key or a soft key.

The user input unit 1130 may receive an input for selecting the one, two or more contents from the user. In addition, the user input unit 1130 may receive an input, from the user, for creating an icon related to a function that can be performed by the character input device 1100.

As described above, the user input unit 1130 may be configured of direction keys, a keypad, a dome switch, a touch pad (resistive/capacitive), a jog wheel, a jog switch or the like.

The sensing unit 1140 senses a current state of the character input device 1100, such as an open and close state of the character input device 1100, a position of the character input device 1100, whether or not a user touches the character input device 1100, an orientation of the character input device, acceleration/deceleration of the character input device or the like, and generates a sensing signal for controlling operation of the character input device 1100. For example, if the character input device 1100 is a type of a slide phone, whether the slide phone is open or closed can be sensed. In addition, it may also sense whether or not power of the battery 1190 is supplied, whether or not the interface unit 1170 is combined with an external device, or the like. Meanwhile, the sensing unit 1140 may include a proximity sensor 1141. The proximity sensor 1141 will be described below in relation to a touch screen.

The output unit 1150 is for generating an output related to the sense of sight, hearing and touch and may include a display unit 1151, a sound output module 1152, an alarm unit 1153, a haptic module 1154, a projector module 1155 and the like.

The display unit 1151 displays (outputs) information processed by the character input device 1100. For example, when the character input device is in the communication mode, the display unit 1151 displays a User Interface (UI) or a Graphic User Interface (GUI) related to communication. When the character input device 1100 is in the video communication mode or the photographing mode, the display unit 1151 displays a photographed and/or received image, or a UI or a GUI.

In addition, the display unit 1151 according to the present invention supports a 2D or 3D display mode.

That is, the display unit 1151 according to the present invention may have a configuration of combining a switch liquid crystal 1151b with a general display device 1151a, as shown in FIG. 9. In addition, the display unit 1151 may control the propagation direction of light by operating an optical parallax barrier 50 using the switch liquid crystal 1151b to separate the light so that different lights may arrive at the left and right eyes. Therefore, when an image combining a right eye image and a left eye image is displayed on the display device 1151a, a user may feel that the images corresponding to corresponding eyes are seen as if a three-dimensional image.

That is, under the control of the control unit 1180, the display unit 1151 does not drive the switch liquid crystal 1151b and the optical parallax barrier 50 and performs a general 2D display operation by driving only the display device 1151a in a state of a 2D display mode.

In addition, under the control of the control unit 1180, the display unit 1151 performs a 3D display operation by driving the switch liquid crystal 1151b, the optical parallax barrier 50 and the display device 1151a in a state of a 3D display mode.

Meanwhile, the display unit 1151 described above may include at least one of a liquid crystal display (LCD), a thin film transistor-liquid crystal display (TFT LCD), an organic light-emitting diode (OLED), a flexible display and a 3D display.

Some displays among these may be configured as a transparent type or an optical transmission type so as to see outside through the display. This may be called as a transparent display, and a representative example of the transparent display is a Transparent OLED (TOLED) or the like. The back end structure of the display unit 1151 may also be configured in an optical transmission structure. According to such a structure, a user may see an object positioned at the rear side of the body of the character input device through an area occupied by the display unit 1151 of the body of the character input device.

Two or more display units 1151 may exist according to an implementation form of the character input device 1100. For example, in the character input device 1100, a plurality of display units may be arranged to be spaced apart from each other or in an integrated manner on a surface or may be arranged on different surfaces.

When the display unit 1151 and a sensor which senses a touch operation (hereinafter, referred to as a ‘touch sensor’) configure a layered structure with each other (hereinafter, referred to as a ‘touch screen’), the display unit 1151 can be used as an input device as well as an output device. The touch sensor may have a form such as a touch film, a touch sheet, a touch pad or the like.

The touch sensor may be configured to convert a change in the pressure applied to a specific portion of the display unit 1151 or capacitance or the like generated at a specific portion of the display unit 1151 into an electrical input signal. The touch sensor may be configured to detect even a pressure at the time point of a touch, as well as the position and area of the touch.

When a touch input is detected by the touch sensor, a signal (signals) corresponding thereto is sent to a touch controller (not shown). The touch controller transmits a corresponding data to the control unit 1180 after processing the signal (signals). Therefore, the control unit 1180 may know which part of the display unit 1151 is touched.

The proximity sensor 1141 may be arranged in an inner area of the character input device wrapped by the touch screen or in the vicinity of the touch screen. The proximity sensor is a sensor for detecting existence of an object approaching a certain detection surface or an object existing in the neighborhood using electromagnetic force or infrared rays without mechanical contact. The proximity sensor has a long lifespan compared with a contact-type sensor, and its utilization is also high.

Examples of the proximity sensor are a through-beam photoelectric sensor, a direct reflection type photoelectric sensor, a mirror reflection type photoelectric sensor, a high frequency oscillation proximity sensor, a capacitive proximity sensor, a magnetic proximity sensor, an infrared proximity sensor and the like. When the touch screen is a capacitive type, it is configured to detect approach of a pointer based on a change in the electric field according to the approach of the pointer. In this case, the touch screen (touch sensor) may be classified as a proximity sensor.

Hereinafter, for the convenience of explanation, a behavior of recognizing a pointer approaching without contacting the touch screen and positioned on the touch screen is referred to as a “proximity touch”, and a behavior of actually contacting the pointer on the touch screen is referred to as a “contact touch”. A position on the touch screen proximately touched by the pointer means a position on the touch screen vertically corresponding to the pointer when the pointer proximately touches the touch screen.

The proximity sensor senses a proximity touch and a proximity touch pattern (e.g., a proximity touch distance, a proximity touch direction, a proximity touch speed, a proximity touch time, a proximity touch position, a proximity touch movement state and the like). Information corresponding to the sensed proximity touch operation and proximity touch pattern may be output on the touch screen.

The sound output module 1152 may output audio data received from the wireless communication unit 1110 or stored in the memory 1160 in a call signal receiving mode, a communicating or recording mode, a voice recognition mode, a broadcast receiving mode or the like. The sound output module 1152 also outputs a sound signal related to a function (e.g., a call signal receiving sound, a message receiving sound or the like) performed by the character input device 1100. The sound output module 1152 may include a receiver, a speaker, a buzzer and the like.

The alarm unit 1153 outputs a signal for informing generation of an event in the character input device 1100. Examples of the event generated in the character input device are reception of a call signal, reception of a message, input of a key signal, input of a touch and the like. The alarm unit 1153 may also output a signal for informing generation of an event in a different form other than a video signal or an audio signal, such as vibration. Since the video signal or the audio signal can be output through the display unit 1151 or the sound output module 1152, in this case, the display unit 1151 and the sound output module 1152 can be classified as a kind of the alarm unit 1153.

The haptic module 1154 generates various tactile effects that a user may feel. A representative example of the tactile effect generated by the haptic module 1154 is vibration. The strength, pattern and the like of the vibration generated by the haptic module 1154 can be controlled. For example, it is possible to output various vibrations after synthesizing the vibrations or sequentially output the vibrations.

In addition to the vibrations, the haptic module 1154 may generate various tactile effects, such as an effect generated by a stimulus such as an array of pins vertically moving onto a contacted skin surface, air injection or suction power through an injection hole or a suction hole, a slight touch on the skin surface, contact of an electrode, electrostatic force or the like, or an effect generated by reproducing a sense of feeling coldness and warmth using an element capable of absorbing or generating heat.

The haptic module 1154 may be implemented to transfer the tactile effect through a direct touch and, in addition, to allows a user to feel the tactile effect through a muscular sense of a finger or an arm. Two or more haptic modules 1154 can be provided according to a configurational aspect of the character input device 1100.

The projector module 1155 is a constitutional component for performing an image project function using the character input device 1100, and it may display an image the same as or at least partially different from an image displayed on the display unit 1151 on an external screen or a wall according to a control signal of the control unit 1180.

Specifically, the projector module 1155 may include a light source (not shown) for generating light (e.g., a laser beam) to output an image to outside, an image creation means (not shown) for creating an image to be output to outside using the light generated by the light source, and a lens (not shown) for outputting an enlarged image to outside at a certain focal point. In addition, the projector module 1155 may include a device (not shown) capable of adjusting a direction of image projection by mechanically moving the lens or the entire module.

The projector module 1155 can be divided into a Cathode Ray Tube (CRT) module, a Liquid Crystal Display (LCD) module, a Digital Light Processing (DLP) module and the like according to the type of element of a display means. Particularly, the DLP module is implemented in a method of enlarging and projecting an image created when the light generated by the light source is reflected by a Digital Micromirror Device (DMD) chip, and this may be advantageous for miniaturization of the projector module 1155.

Preferably, the projector module 1155 may be provided in the longitudinal direction on the side surface, front surface or rear surface of the character input device 1100. Of course, it is natural that the projector module 1155 can be provided at any position of the character input device 1100 as needed.

The memory 1160 may store a program for the process and control of the control unit 1180 and may also perform a function of temporarily storing input and output data (e.g., a phone book, a message, an audio, a still image, an electronic book, a moving image, history of transmitted and received messages and the like). The memory 1160 may also store a frequency of using each of the data (e.g., a frequency of using each phone book, message or multimedia data). In addition, the memory 1160 may store data related to various patterns of vibrations and sounds which are output when a touch on the touch screen is input.

In addition, the memory 1160 stores a web browser for displaying a 3D or 2D web page according to the present invention.

The memory 1160 described above may include at least a type of storage medium including memory of a flash memory type, a hard disk type, a multimedia card micro type or a card type (e.g., SD or XD memory), RAM (Random Access Memory), Static Random Access Memory (SRAM), Read-Only Memory (ROM), Electrically Erasable Programmable Read-Only Memory (EEPROM), Programmable Read-Only Memory (PROM), magnetic memory, a magnetic disk, and an optical disk. The character input device 1100 may operate in relation to a web storage which performs a storage function of the memory 1160 on the Internet.

The interface unit 1170 functions as a passage to all external devices connected to the character input device 1100. The interface unit 1170 receives data from an external device, receives and transfers power to each constitutional component in the character input device 1100, or transmits internal data of the character input device 1100 to the external device. For example, a wired/wireless headset port, an external charger port, a wired/wireless data port, a memory card port, a port for connecting a device having an identification module, an audio Input/Output (I/O) port, a video Input/Output (I/O) port, an earphone port and the like can be included in the interface unit 1170.

The identification module is a chip for storing various kinds of information for authenticating a right to use the character input device 1100 and may include a User Identify Module (UIM), a Subscriber Identify Module (SIM), a Universal Subscriber Identity Module (USIM) and the like. A device provided with the identification module (hereinafter, referred to as an ‘identification device’) may be manufactured in the form of a smart card. Accordingly, the identification device can be connected to the character input device 1100 through a port.

When the character input device 1100 is connected to an external cradle, the interface unit can be a passage for supplying power from the cradle to the character input device 1100 or a passage for transferring various types of command signals input from the cradle by a user into the character input device. The various types of command signals or the power input from the cradle may function as a signal for recognizing that the character input device is correctly mounted on the cradle.

Generally, the control unit 1180 controls general operation of the character input device. For example, the control unit 1180 performs related controls and processes for voice communication, data communication, video communication or the like. The control unit 1180 may be provided with a multimedia module 1181 for multimedia playback. The multimedia module 1181 may be implemented within the control unit 1180 or implemented to be separate from the control unit 1180.

A character input function applying the SBP can be implemented under the control of the control unit 1180.

The control unit 1180 may perform a pattern recognition process for recognizing a script input or a drawing input performed on the touch screen as characters or images.

Meanwhile, when the display unit 1151 is configured of organic light-emitting diodes (OLED) or Transparent OLEDs (TOLED), if the size of a preview image input through the camera 1121 is adjusted by handling of a user while the preview image is pull-up displayed on the screen of the organic light-emitting diodes (OLED) or Transparent OLEDs (TOLED) according to the present invention, the control unit 1180 may reduce consumption of power supplied from the power supply unit 1190 to the display unit 1151 by turning off drive of pixels in a second region other than a first region of the screen in which the preview image of an adjusted size is displayed.

The power supply unit 1190 is supplied with external power and internal power and supplies power needed for operation of each constitutional component, under the control of the control unit 1180.

Various embodiments described here can be implemented for example in a recording medium which can be read by a computer or an apparatus similar to the computer, using software, hardware or a combination of these.

According to hardware implementation, the embodiments described here can be implemented using at least one of an application specific integrated circuit (ASIC), a digital signal processor (DSP), a digital signal processing device (DSPD), a programmable logic device (PLD), a field programmable gate arrays (FPGA), a processor, a controller, a micro-controller, a microprocessor and an electrical unit for performing other functions. In some cases, the embodiments described in this specification can be implemented as the control unit 1180 itself.

According to software implementation, embodiments such as the procedures and functions described in this specification can be implemented as separate software modules. Each of the software modules may perform one or more functions and operations described in this specification. A software code can be implemented as a software application written in an appropriate programming language. The software code may be stored in the memory 1160 and executed by the control unit 1180.

Meanwhile, the present invention can be implemented as a computer-readable code in a computer-readable recording medium. The computer-readable recording medium includes all kinds of recording devices for storing data that can be read by a computer system. Examples of the computer-readable recording medium are ROM, RAM, CD-ROM, a magnetic tape, a floppy disk, an optical data storage device and the like, and, in addition, a medium implemented in the form of a carrier wave (e.g., transmission through the Internet) is also included. In addition, the computer-readable recording medium may be distributed in computer systems connected through a network, and a code that can be read by a computer in a distributed manner can be stored and executed therein. In addition, functional programs, codes and code segments for implementing the present invention can be easily inferred by programmers in the art.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A character input method using an event-related potential (ERP), the method comprising the steps of:
determining a first character to be input by a user among thirty six characters included in a 6×6 matrix;
randomly flashing once for each of a plurality of sub-matrixes configured as a 2×3 matrix including six different characters among the 6×6 matrix;
counting the number of times of flashes by the user when a first sub-matrix including the first character flashes among the plurality of sub-matrixes;
generating the event-related potential (ERP) by the counting operation of the user; and
extracting the first character using the generated ERP.

2. The method according to claim 1, wherein the step of randomly flashing once for each of a plurality of sub-matrixes is a first trial, and the first trial includes thirty six times of flashes in total.

3. The method according to claim 2, wherein when the first trial is completed and the first character among the thirty six characters included in the 6×6 matrix flashes six times, characters on left and right sides of the first character respectively flash four times, characters above and below the first character respectively flash three times, and characters nearest to a diagonal line of the first character respectively flash twice together with first character.

4. The method according to claim 1, wherein when a first sub-matrix which is any one of the plurality of sub-matrixes flashes, other sub-matrixes which does not have a character overlapped with the first sub-matrix flash two or more times before any character among the six characters included in the first sub-matrix flashes again.

5. The method according to claim 1, further comprising:
a first step of randomly flashing, in the 6×6 matrix, once for each of a plurality of sub-matrixes configured as a 2×3 matrix including six different characters among the 6×6 matrix;
a second step of performing a stepwise linear discriminant analysis on the ERP generated through the first step; and
a third step of calculating a first discriminant function for discriminating a target stimulus and a non-target stimulus through the stepwise linear discriminant analysis, wherein
the first character is extracted using the first discriminant function.

6. The method according to claim 5, further comprising the steps of:
calculating an ERP for each of the thirty six characters by averaging the ERPs generated through the first step;
calculating a probability of each of the thirty six characters for being a target character using the ERPs of the thirty six characters and the first discriminant function; and
deriving a second discriminant function using the calculated probability, wherein
the first character is extracted using the second discriminant function.

7. A recording medium which can be read by a digital processing device, wherein a program of commands that can be executed by the digital processing device to perform a character input method using an event-related potential (ERP) is implemented in a tangible form, and the character input method using the event-related potential (ERP) comprises the steps of:
determining a first character to be input by a user among thirty six characters included in a 6×6 matrix;
randomly flashing once for each of a plurality of sub-matrixes configured as a 2×3 matrix including six different characters among the 6×6 matrix;
counting the number of times of flashes by the user when a first sub-matrix including the first character flashes among the plurality of sub-matrixes;
generating the event-related potential (ERP) by the counting operation of the user; and
extracting the first character using the generated ERP.

8. A character input device using an event-related potential (ERP), the device comprising:
an interface unit connected to a user to acquire specific information from the user;
a display unit for displaying a 6×6 matrix including thirty six characters; and
a control unit for controlling to randomly flash once for each of a plurality of sub-matrixes configured as a 2×3 matrix including six different characters among the 6×6 matrix, wherein
when the first character is determined among the thirty six characters by the user, and a first sub-matrix including the first character among the plurality of sub-matrixes flashes, and the user counts the number of times of the flashing,
the ERP generated from a brain of the user by the counting operation of the user is acquired through the interface unit, and
the control unit controls to extract the first character using the generated ERP and display the extracted first character through the display unit.

9. The device according to claim 8, wherein the step of randomly flashing once for each of a plurality of sub-matrixes is a first trial, and the first trial includes thirty six times of flashes in total.

10. The device according to claim 9, wherein when the first trial is completed and the first character among the thirty six characters included in the 6×6 matrix flashes six times, characters on left and right sides of the first character respectively flash four times, characters above and below the first character respectively flash three times, and characters nearest to a diagonal line of the first character respectively flash twice together with first character.

11. The device according to claim 8, wherein when a first sub-matrix which is any one of the plurality of sub-matrixes flashes, the control unit controls to flash other sub-matrixes which does not have a character overlapped with the first sub-matrix two or more times before any character among the six characters included in the first sub-matrix flashes again.

12. The device according to claim 8, wherein the control unit performs a first step of randomly flashing once for each of a plurality of sub-matrixes configured as a 2×3 matrix including six different characters among the 6×6 matrix, performs a stepwise linear discriminant analysis on the ERP generated through the first step, calculates a first discriminant function for discriminating a target stimulus and a non-target stimulus through the stepwise linear discriminant analysis, and extracts the first character using the first discriminant function.

13. The device according to claim 12, wherein the control unit circulates an ERP for each of the thirty six characters by averaging the ERPs generated through the first step, circulates a probability of each of the thirty six characters for being a target character using the ERPs of the thirty six characters and the first discriminant function, derives a second discriminant function using the calculated probability, and extracts the first character using the second discriminant function.
